(19) United States
(12) Patent Application Publication
(10) Pub. No.: US 2012/0200703 A1
(43) Pub. Date: Aug. 9, 2012

(54) IMAGING SYSTEM FOR UAV

(75) Inventors: Ronen Nadir, Tel-Mond (IL); Motti Shechter, North Bethesda, MD (US); Ronen Barsky, Rishon-le-Zion (IL)

(73) Assignee: BLUEBIRD AERO SYSTEMS LTD., Kadima (IL)

(21) Appl. No.: 13/502,379

(22) PCT Filed: Oct. 21, 2010
(86) PCT No.: PCT/IL10/00871

§ 371 Date: Apr. 17, 2012

(30) Foreign Application Priority Data
Oct. 22, 2009 (IL) 201682

(51) Int. Cl. H04N 7/18

(52) U.S. Cl. 348/144; 348/E07.085

(57) ABSTRACT

There is provided herein a system for providing a stabilized video image with continuously scrollable and automatically controllable Line-Of-Site (LOS) and adjustable Field-Of-View (FOV) for use in an Unmanned Aerial Vehicle (UAV), with no moving parts. The system comprising a plurality of fixed oriented sensors disposed in one or more of orientations, a computing unit comprising processor adapted to define a position of a window of interest (WOI) within one or more field-of-views of said plurality of sensors, read pixels data from said WOI, compensate, in real time, for changes in a target position relative to the UAV and for the UAV attitude by continuously scrolling the position of said WOI and provide a continuous high frame rate video image based on the pixels data from said WOI. The system may also provide retrievable high resolution images of the scene, to be stored in internal memory for later retrieve or transmitted to a Ground Control Station in parallel to the real-time video.

### FIELD OF THE INVENTION

The invention relates to electro-optical imaging. Some embodiments of the invention relate to digital imaging in unmanned aerial vehicle (UAV).

### BACKGROUND OF THE INVENTION

Unmanned Aerial Vehicles (UAVs) are remotely piloted or self-piloted aircraft that can carry cameras, sensors, communications equipment or other payloads. They are used, among other roles, in a reconnaissance and intelligence-gathering. According to size or weight or payload capabilities UAVs are generally ranked as micro-UAV, mini-UAV, mid-size or heavy UAV.

Unmanned Aerial Vehicles are quite prevalent with nearly two hundreds known UAVs (see, for example, Jane's Unmanned Aerial Vehicles and Targets, Publication synopsis, May 5, 2009, www.janes.com/articles/Janes-Unmanned-Aerial-Vehicles-and-Targets/IAI-Heron-TP-Eitan-Israel.html), some of which are listed with references in www.globalsecurity.org/intell/systems/uav.htm.

For visual reconnaissance UAVs typically use imaging systems such as cameras, and in many cases gimbals are used for image direction or stabilization (for example, TASE, A Low-Cost Stabilized Camera Gimbal for Small UAVs, CCT part. 900-90012-00, www.amtechs.co.jp/2_gps/download/catalog/cloudcap/gimbal.pdf).

Due to size, weight or power limitations, in small UAVs such as micro- or mini-UAVs the cameras are often implemented with fixed imaging apparatus, as for example, in the very costly Raven mini UAV (by AeroVironment) that provides unsatisfactory video image from its fixed mounted cameras. Still there is a need in the art for cost effective easy to handle high resolution wide-field-of-view imaging systems for UAVs.

### SUMMARY OF THE INVENTION

An aspect of the invention relates to apparatus and method for generating in a plurality of sensors a wide field-of-view high-resolution seamless image along at least one direction and accessing an arbitrary portion of the image regardless the remainder of the image on the sensors.

According to some embodiments of the invention, the image is generated by a simultaneously triggering a plurality of sensors oriented (aimed) at different directions relative to a scene and simultaneously acquiring image data of different zones of a scene (‘pictures’) along at least one direction of the scene. Once triggered, according to some embodiments, each sensor momentarily stores a picture until the next triggering event. The stored pictures are combined and amended to generate a potential (virtual) wide field-of-view high-resolution seamless image of the scene by the plurality of sensors. A frame (Window Of Interest, WOI) is defined respective to the image and contents of the image (pixels) within the frame are accessed and corrected for possible distortions apart from the rest of the image.

In some embodiments of the invention, the imaging system comprises a plurality of imaging sensors having random (selective) access to individual pixels, such as a CMOS sensor, optionally with computational or logic circuitry built in the sensor and/or coupled with the sensor. By using a sensor with random access, a portion or partial image (sub-image) is defined within a sensor and/or a plurality of sensors and the contents of the sub-image may accessed and handled without accessing the remaining contents of the sensor or sensors, such as if practically the sub-image was acquired by an individual sensor (‘virtual sensor’).

In some embodiments, the sub-image is defined by a frame that is modified in position and size for operations such as panning or zooming or tilting with respect to the image. The frame and the contents of the image within the boundaries of the frame (sub-image) is accessed and handled without accessing pixels of the sensors outside the frame (or at least without accessing a substantial part of the image outside the frame). In some preferred embodiments of the invention, the frame and sub-image are handled in real-time.

In some embodiments, the sub-image constitutes a contiguous portion. Optionally or additionally, the sub-image comprises a plurality of contiguous sub-images defined by a respective plurality of frames, providing a plurality of ‘view ports’ in the high-resolution continuous image.

In some embodiments of the invention, the sub-image is processed for storage and/or transmission such as conversion to a standard format or as a sequence in television format forming a video stream. In some embodiments of the invention, the sub-images as a still or video stream are saved in the imaging system or a coupled apparatus, along with coupled metadata for later retrieval such as after landing or later during flight. Optionally or additionally, the sub-images or video stream is transmitted to another apparatus such as a ground station or a relay apparatus.

In preferred embodiments, handling, storing and transmission of the sub-images or video stream are performed in real-time during the operation of the imaging system. By accessing only a sub-image regardless of the rest of the image the contents of the sub-image can be processed faster than by accessing (reading) the whole image or a substantial part thereof, allowing real-time operations, higher resolution and faster frame rate without disrupting or interfering in or delaying the on-going repeating imaging course (e.g. acquisition, processing, transmission and/or storing).

In some embodiments, the high-resolution seamless image along at least one direction is formed as a high-resolution seamless image along two directions, forming a cross-like pattern or rectangular pattern or any other pattern.

In some embodiments, the pictures acquisition and processing is carried out by an imaging system comprising a plurality of cameras mounted on a support structure. The cameras are directed towards different zones in a scene and acquire on sensors thereof synchronized different pictures which are amended or corrected for distortions (deformations) such as perspective and seamlessly stitched to form in the sensors a continuous image corresponding to a common plane on or over the scene.

In preferred embodiments of the invention the cameras are fixedly mounted on the support structure forming a rigid system, where all the operations of the imaging system (such as panning, zooming or tilting with respect to the image) are carried electronically without moving or rotating any part or component.

In some preferred embodiments of the invention, the imaging system is installable in a UAV and operable during the UAV flight. Optionally or alternatively, the imaging system is installable on other platforms such as an aerostat balloon or a ground fixed fence or tower.

In some embodiments of the invention, the imaging system is sufficiently small and light-weight to fit and operate in a small UAV such as micro-UAV or mini-UAV. In some embodiments, the sensors or cameras (e.g. sensor and/or lens and/or image acquisition control apparatus) are commercially available at a low-cost relative to custom designed and manufactured corresponding articles.

In the specification and claims the following terms and derivatives and inflections thereof imply the respective non-limiting characterizations below, unless otherwise specified or evident from the context.

Rigid—fixed, non-movable construction.

Sensor—an apparatus responsive to radiation and comprising a plurality of elements (pixels) holding (storing) values related to the radiation.

High-resolution—significantly higher resolution relative to standard resolution such as PAL or NTSC or VGA resolution, like for example HD (high definition 1080×1920).

Wide Field-Of-View (FOV)—having FOV significantly larger than a common FOV of a sensor and lens (30-70 deg), such as 180-360 deg.

Arbitrary—not restricted within the physical boundaries of the apparatus.

Camera—an image acquisition apparatus comprising an imaging sensor and auxiliary optical (e.g. lens) or other element or elements (for example, mechanical or control circuitry).

Scene—an area intended for viewing or surveying, such as ground, sea, air or any combination thereof.

Real-time—instantaneous or immediate, at least approximately, relative to other operational timing or delays of the respective apparatus or system.

Synchronized—having common operation timing, at least approximately.

Coupled—closely linked circuitry, typically with respect to performance timing, such as FPGA sharing data and control lines with a sensor, or resembling a chip-set.

Path of flight (of a UAV)—the direction of flight as projected on the scene.

Standard format/resolution—a format in terms of aspect ratio and/or resolution common in the TV or computer graphic art, such as PAL, NTSC, HDTV or VGA or XVGA, typically, but not necessarily encoded in a format such as JPEG or H.264.

In/on a sensor—relates to pixels held or stored in or on the sensor (rather than pixels copied to a memory).

Seamless (image)—contiguous or continuous image of a scene without missing or repeated parts, and without image breakage(s), at least to a close approximation.

Picture—an image as captured by a sensor (possibly with perspective and optical distortions), including for example IR or UV images.

Tile—a picture after corrections such as of geometrical and/or perspective distortions (if required) and elimination of overlap with adjoining pictures.

Virtual (image)—an image (or part thereof) that materializes (formed) when accessed (read), typically via transformation for correcting distortions and/or overlapping and/or misalignment, from one or more sensors.

Rectified (image, window)—corrected for angular and/or lens distortions, at least for coarse distortions, including when required compensation for overlapping regions and/or alignment or regions (in sensors or memory).

Sub-image—a part of an image (such as window of interest).

Accessing (a sensor)—addressing, for reading at least, pixels on a sensor.

Accessing a portion regardless of an image—not accessing the image outside the portion, at least not a substantial part of the image outside the portion as accessing a limited number of pixels (relative to the image) might be required for auxiliary operations such as stitching or corrections.

There is provided herein, according to an aspect of some embodiments of the present invention, a system for providing a continuously scrollable stabilized video image with automatically controllable Line-Of-Site (LOS) and adjustable Field-Of-View (FOV) for use in an Unmanned Aerial Vehicle (UAV), the system comprising:

a plurality of sensors disposed in one or more of orientations;

a computing unit comprising processor adapted to:

define a position (and optionally size) of a window of interest (WOI) within one or more field-of-views of said plurality of sensors, in order to view a Target Of Interest (TOI);

read pixels data from said WOI; compensate, in real time, for changes in said TOI's position relative to the UAV (due to the flight path) and for the UAV attitude by, continuously scrolling the position of said WOI (for example, by moving the WOI horizontally or vertically such that new information appears on one side of the frame as older information disappears from the other side); and

provide a continuous high frame rate video image based on the pixels data from said WOI.

in some embodiments, said computing unit further comprises a Field-Programmable Gate (FPGA) and an interface component adapted to manage and collect information from the sensors and wherein said processor is an image processing Digital Signal Processor (DSP).

In some embodiments, the system is further adapted to provide retrievable high-resolution still images, wherein said processor is further adapted to retrievably store high resolution still images with related information in an internal memory device.

In some embodiments, said plurality of sensors further comprise one or more lenses adapted to control the field-of-view and resolution of said video image and/or still images.

In some embodiments, said plurality of sensors are disposed in a plurality of orientations.

In some embodiments, providing said video image is performed after the step of compensating, in real time, for changes in said target position relative to the UAV and for the UAV attitude.

In some embodiments, said position of said window of interest (WOI) is defined based on a command received from a Ground Control Station (GCS).

In some embodiments, said processor is further adapted to continuously (smoothly) resize the WOI upon Ground Control Station (GCS) command or upon automatic selection defined by a mode of operation.

In some embodiments, said continuous video image is a wide field-of-view video image.

In some embodiments, said image comprises of information taken from one sensor or more.

In some embodiments, the system further comprises a transmitter adapted to transmit said continuous video image to a Ground Control Station (GCS), in high frame rate and in multiple resolutions.

In some embodiments, said transmission comprises PAL 576×720 and HD 1080×1920.

In some embodiments, said processor is further adapted to read pixels data from essentially all sensors and to store said data (optionally in parallel of the video transmission).

In some embodiments, the system further comprises a memory adapted to store one or more images along with related metadata.

In some embodiments, said processor is further adapted, upon receiving a command from a user, to pull from storage one or more images (based on the coupled metadata) and to trigger a transmitter to transmit to a Ground Control Station (GCS) said one or more images.

In some embodiments, said processor is further adapted to stabilize said video image by using one or more image processing algorithms.

In some embodiments, said one or more image processing algorithms comprise maintaining pixels of interest in essentially the same position relative to a screen.

In some embodiments, said sensors are positioned in any desired positions, orientations or both, such that a required scene is covered.

In some embodiments, said processor is further adapted to synchronize the pixels data read from said plurality of sensors and to correct the pixels data for distortions, such as to produce a seamlessly stitched video image.

In some embodiments, said processor is adapted to operate in an all digital mode, adapted to output digitally compressed video stream instead of analog video.

In some embodiments, said processor is further adapted to encrypt the digitally compressed video stream.

In some embodiments, said transmitter is adapted to operate in an all digital mode, adapted to transmit compressed digital information with error correction algorithm.

In some embodiments, at least two of said plurality of sensors are of spectra frequencies different from each other, wherein said at least two of said plurality of sensors are looking to essentially the same line-of-site.

In some embodiments, at least two of said plurality of sensors are of spectra frequencies different from each other, wherein said at least two of said plurality of sensors are looking to different line-of-sites.

In some embodiments, aid spectra frequencies are selected from the group consisting of, Visible, Ultra-Violet, Visible-Near Infra Red, Short Wave Infrared, Mid Wave Infrared and Long Wave Infrared.

According to an aspect of some embodiments of the present invention there is provided a method for providing a continuously scrollable stabilized video image with automatically controllable Line-Of-Site (LOS) and adjustable Field-Of-View (FOV) for use in an Unmanned Aerial Vehicle (UAV), the method comprising:

defining a position and size of a window of interest (WOI) within one or more of a plurality of sensors disposed in one or more orientations, in order to view a Target Of Interest (TOI);

reading pixels data from said WOI;

compensating, in real time, for changes in said TOI's position relative to the UAV and for the UAV attitude by continuously scrolling the position of said WOI; and

providing a continuous video image based on the pixels data from said WOI.

In some embodiments, the method further comprises providing retrievable high-resolution still images and retrievably storing said high resolution still images with related information in an internal memory device.

In some embodiments, said plurality of sensors further comprise one or more lenses adapted to control the field-of-view and resolution of said video image and/or still images.

In some embodiments, said plurality of sensors are disposed in a plurality of orientations.

In some embodiments, providing said video image is performed after the step of compensating, in real time, for changes in said target position relative to the UAV and for the UAV attitude.

In some embodiments, said position of said window of interest (WOI) is defined based on a command received from a Ground Control Station (GCS).

In some embodiments, the method further comprises continuously resizing the WOI upon operator Ground Control Station (GCS) command or upon automatic selection defined by the mode of operation.

In some embodiments, said continuous video image is a wide field-of-view video image.

In some embodiments, said image comprises of information taken from one sensor or more.

In some embodiments, the method further comprises transmitting said continuous video image to a Ground Control Station (GCS), in high frame rate and in multiple resolutions.

In some embodiments, said transmission comprises PAL 576×720 and HD 1080×1920.

In some embodiments, the method further comprises reading pixels data from essentially all sensors and storing said data.

In some embodiments, the method further comprises storing one or more images along with related metadata.

In some embodiments, the method further comprises, upon receiving a command from a user, pulling from storage one or more images and transmitting to a Ground Control Station (GCS) said one or more images.

In some embodiments, the method further comprises stabilizing said video image by using one or more image processing capabilities.

In some embodiments, using one or more image processing capabilities comprises maintaining pixels of interest in essentially the same position relative to a screen.

In some embodiments, the method further comprises positioning the sensors in any desired positions, orientations or both, such that a required scene is covered.

In some embodiments, the method further comprises synchronizing the pixels data read from said plurality of sensors and correcting the pixels data for distortions, such as to produce a seamlessly stitched video image.

In some embodiments, the method is operated in an all-digital mode.

In some embodiments, at least two of said plurality of sensors are of spectra frequencies different from each other.

In some embodiments, said spectra frequencies are selected from the group consisting of, Visible, Ultra-Violet, Visible-Near Infra Red, Short Wave Infrared, Mid Wave Infrared and Long Wave Infrared.

According to an aspect of some embodiments of the present invention there is provided an Unmanned Aerial Vehicle (UAV) comprising a system for providing a continuously scrollable stabilized video image with automatically controllable Line-Of-Site (LOS) and adjustable Field-Of-View (FOV) for use in an, the system comprising:

a plurality of sensors disposed in one or more of orientations;

a computing unit comprising a processor adapted to:

define a position and size of a window of interest (WOI) within one or more field-of-views of said plurality of sensors, in order to view a Target Of Interest (TOI);

read pixels data from said WOI;

compensate, in real time, for changes in said TOI's position relative to the UAV and for the UAV attitude by, continuously scrolling the position of said WOI; and

provide a continuous high frame rate video image based on the pixels data from said WOI.

In some embodiments, said system is further adapted to provide retrievable high-resolution still images, wherein said processor is further adapted to retrievabley store high resolution still images with related information in an internal memory device.

In some embodiments, said plurality of sensors further comprise one or more lenses adapted to control the resolution of said video image and/or still images.

### BRIEF DESCRIPTION OF THE DRAWINGS

Some non-limiting exemplary embodiments of the invention are illustrated in the following drawings.

Identical or duplicate or equivalent or similar structures, elements, or parts that appear in one or more drawings are generally labeled with the same reference numeral, optionally with an additional letter or letters to distinguish between similar objects or variants of objects, and may not be repeatedly labeled and/or described.

Dimensions of components and features shown in the figures are chosen for convenience or clarity of presentation and are not necessarily shown to scale or true perspective. For convenience or clarity, some elements or structures are not shown or shown only partially and/or with different perspective or from different point of views.

It should be noted that some figures were converted to black-and-white rendering, thereby degrading the pictorial quality such as by reducing certain details or texture or fineness.

FIG. 1A illustrates an approximate perspective side view (after conversion to black-and-white) of a rigid imaging system installable and operable on a micro UAV, according to exemplary embodiments of the invention (including computing unit and five sensors, excluding the flat cables to the sensors);

FIG. 1B illustrates an approximate perspective rear view (after conversion to black-and-white) of a rigid imaging system installable and operable on a micro UAV, according to exemplary embodiments of the invention;

FIG. 2A schematically illustrates the rigid imaging system of FIGS. 1A-B installed on a micro UAV and the angularly distorted zones of pictures captured by the sensors of the system, according to exemplary embodiments of the invention;

FIG. 2B schematically illustrates rectangular tiles after correcting the distortions of corresponding angularly distorted zones of FIG. 2A, according to exemplary embodiments of the invention;

FIG. 2C schematically illustrates a wide field-of-view contiguous image formed by combination of rectangular tiles after correcting the distortions of corresponding angularly distorted zones of FIG. 2A, and after applying the seamless stitching algorithm according to exemplary embodiments of the invention;

FIG. 3 schematically illustrates a block diagram for forming a contiguous image from a plurality of sensors, according to exemplary embodiments of the invention;

FIG. 4A schematically illustrates a window-of-interest as a sub-frame in a standard aspect ratio inside a single sensor, according to exemplary embodiments of the invention;

FIG. 4B-C schematically illustrates a window-of-interest as dual sub-frames in a standard aspect ratio on a boundary between two sensors, according to exemplary embodiments of the invention;

FIG. 4D schematically illustrates a window-of-interest as three sub-frames of standard aspect ratio on boundaries between three sensors, according to exemplary embodiments of the invention;

FIG. 5A schematically illustrates an unrestricted window-of-interest in a viewing mode, according to exemplary embodiments of the invention;

FIG. 5B schematically illustrates a window-of-interest matching a tile in a viewing mode, according to exemplary embodiments of the invention;

FIG. 5C schematically illustrates a wide-field-of-view window-of-interest matching three consecutive tiles in a viewing mode, according to exemplary embodiments of the invention;

FIG. 5D schematically illustrates a wide-field-of-view window-of-interest matching three consecutive tiles in a viewing mode orthogonal to that of FIG. 4C, according to exemplary embodiments of the invention;

FIG. 5E schematically illustrates a wide-field-of-view window-of-interest matching the whole image in a viewing mode, according to exemplary embodiments of the invention;

FIG. 6 schematically outlines a sequence of operations according to exemplary embodiments of the invention;

FIG. 7A schematically outlines a cross-like field of view formed by nine pictures, according to exemplary embodiments of the invention;

FIG. 7B schematically outlines a non-symmetrical cross-like field of view formed by eight pictures, according to exemplary embodiments of the invention;

FIG. 7C schematically outlines a unidirectional field of view formed by three pictures, according to exemplary embodiments of the invention;

FIG. 7D schematically outlines a unidirectional field of view formed by five pictures, according to exemplary embodiments of the invention;

FIG. 7E schematically outlines a field of view formed by six dually-lined pictures, according to exemplary embodiments of the invention; and

FIG. 7F schematically outlines a field of view formed by nine pictures, according to exemplary embodiments of the invention.

### DESCRIPTION OF EMBODIMENTS OF THE INVENTION

The following description relates to one or more non-limiting examples of embodiments of the invention. The invention is not limited by the described embodiments or drawings, and may be practiced in various manners or configurations or variations. The terminology used herein should not be understood as limiting unless otherwise specified.

The non-limiting section headings used herein are intended for convenience only and should not be construed as limiting the scope of the invention.

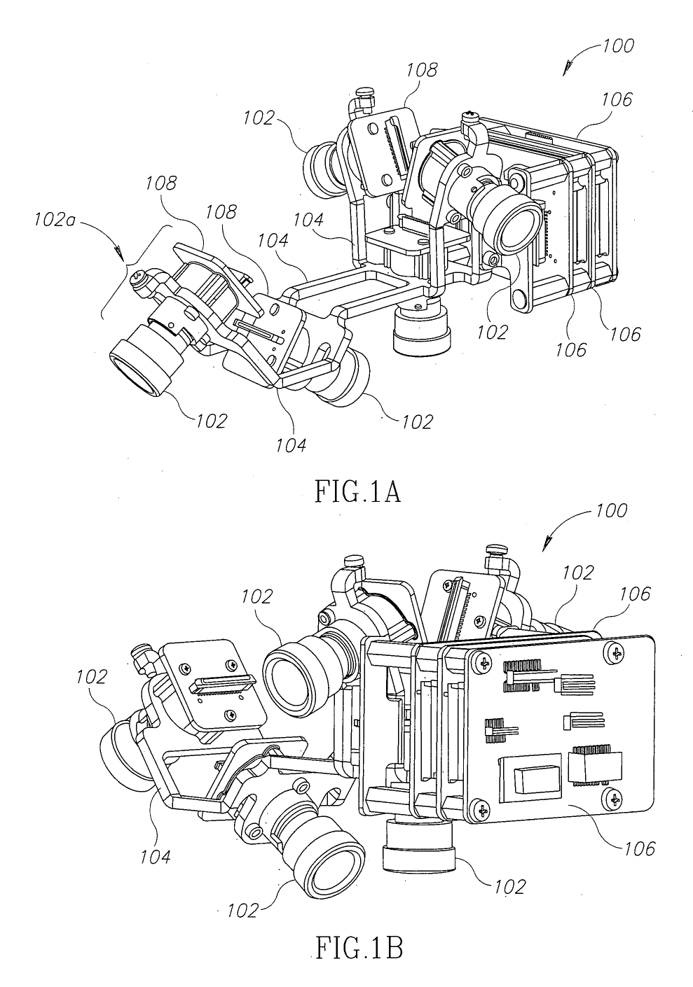

FIG. 1A illustrates an approximate perspective side view (after conversion to black-and-white) of a rigid imaging system 100, and FIG. 1B illustrates an approximate perspective rear view (after conversion to black-and-white) of imaging system 100, according to exemplary embodiments of the invention.

System 100 comprises (a) a support structure 104, (b) cameras 102 and a control board or boards 106.

Five cameras 102 are mounted on inclined planes 108 (relative to each other) for capturing adjacent, possibly partially overlapping, pictures in different directions

In some embodiments, camera 102 comprises (a) an imaging sensor, preferably having random access to particular selected pixels, such as a CMOS sensor, (b) an optical element or elements such as a lens or other such as IR filter, and (c) optional interface control circuitry built in the sensor and/or coupled with the sensor, such as FPGA or ASIC. In some embodiments, the logic circuitries of camera 102 are connected or simultaneously controlled to provide synchronization of pictures captures timing (e.g. shared synch line) and optionally provide or cooperate in controlling access to pixels of the sensor. For clarity, cameras 102 are indicated by a lens thereof, but reference is made to the whole camera as indicated by dotted bracket 102a in FIG. 1A.

Imaging system 100 is operated via control boards 106 that control cameras 102, in terms such as pictures acquisition and timing control, pictures manipulation, storage and optional communication to and/or from another apparatus such as a ground station or a relay apparatus.

In some embodiments, pictures manipulation comprise operations such as stitching of pictures into a larger image and/or different image, panning and zooming or tilting in the image, correction of angular distortions, video streaming or other image processing or enhancements such as sharpening or deblurring.

In some embodiments, control boards 106 employ one or more processors, such as DSP and/or general purpose processor and/or custom logic circuitry such as FPGA or ASIC, controlled or coordinated by one or more programs stored in or on boards 106.

The five cameras 102 of imaging system 100 represents any number of cameras 102 as suitable for the tasks described below, and boards 106 represents one or more boards (referred to as a plurality of boards 106) comprising electronic circuitry or units or modules or other equipment such as antenna

In some embodiments of the invention, system 100 installable and operable on a UAV as a reconnaissance payload. In some preferred embodiments of the invention, system 100 has sufficiently small size, weight (e.g. <200 gr) and power consumption for installing and operating in small UAVs such as micro-UAV (weighing about 1 kg).

In some preferred embodiments of the invention, components used in system 100 such as sensors, lenses or hardware (or software modules such as stabilization software) are commercially available, preferably as off-the-shelf inexpensive or low-end items, enabling to reduce or minimize the costs, at least relative to custom-made items or high-end expensive elements.

For clarity and brevity in the following descriptions, in referring to an imaging system and operation thereof it is assumed as non-limiting examples that the imaging system is mounted on and operating in a flying UAV, unless otherwise specified or unambiguously evident from the context. As a non-limiting illustration, reference is made to FIGS. 1A-B in the descriptions bellows.

### Overview

A general non-limiting overview of practicing the invention is presented below. The overview outlines exemplary practice of embodiments of the invention, providing a constructive basis for variant and/or alternative and/or divergent embodiments, some of which are subsequently described.

As the UAV is flying, the sensors of the plurality of cameras 102 acquire a plurality of high resolution pictures of a scene at different directions, possibly with some overlapping at adjoining margins, collectively covering a high resolution large field-of-view of the scene. It is noted that the cameras indicated by the number 102 may be identical or different from each other.

A window of interest (WOI or viewing port) as a sub-image defined by an outline or frame (‘window’) is determined or set by the computing unit 106 respective to the image on the sensors, wherein the WOI is zoomed, tilted and/or panned about the image on the sensors by changing parameters of the window. The contents (pixels) within the WOI is read by the computing unit 106 without accessing the rest of the image. The read pixels are combined (stitched) and amended for possible deformations such as perspective to form a practically contiguous image which become a video frame in a continuous video stream, sent to a destination such as control station preferably in real-time and optionally stored within system 100.

Upon command, a larger frame can be saved into memory as a high resolution image.

The operation of system 100 is carried out without moving any part thereof.

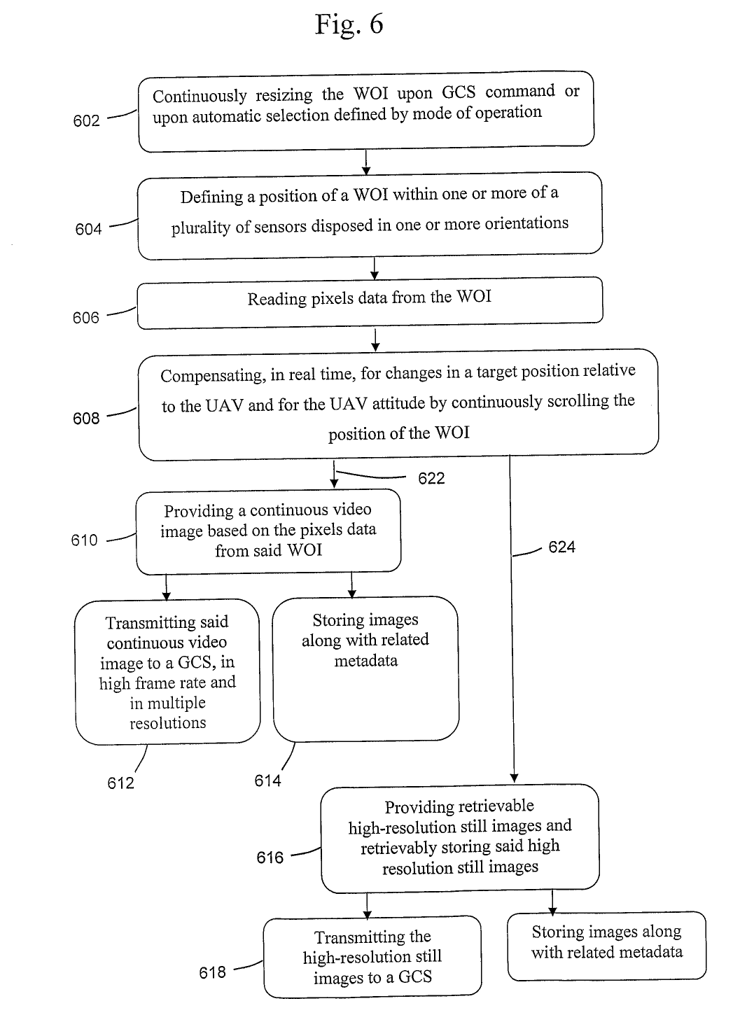

Reference is made also to FIGS. 6A-B that outline exemplary operations sequence.

### Deformations and Transformations

In some embodiments, cameras 102 capture pictures in inclined directions that cause the picture to be geometrically skewed (perspective or angular deformation or distortion). In some cases the pictures taken by cameras 102 are misaligned such as by some relative shift or rotation. Another cause of distortions is aberrations of the lenses used in cameras 102. Another cause of distortions is the Rolling Shutter mode of operation of the CMOS sensor.

Working with and manipulating windows in an angularly distorted image can be inconvenient such as programmatically or problematic such as in panning or zooming a window. Therefore, in some embodiments of the invention, the pictures are amended or corrected into corresponding rectangular parts (‘tiles’) which are eventually combined to form a rectified contiguous image.

In some embodiments, the correction for angularity distortions or other deformations such as some lens aberrations is expressed as one or more parameters in one or more preset formulas such as projection formulas, or as determined formulas such as by convergence, or a combination thereof, or optionally or additionally, as one or more lookup tables (collectively referred to as ‘formulas’ for brevity). Preferably, the formulas are determined on the ground or in test flights, or optionally during the operational flight. In some embodiments, the formulas (such as parameters) are periodically checked and or adjusted during an operational flight.

It should be noted that in many cases the corrections, and hence the formulas, depend on the flight characteristics of the vehicle (e.g. attitude and altitude). Therefore, in some embodiments, system 100 provides the necessary parameters from one or more of the vehicle's flight control, instruments, or sensors such as inclinometers and pressure sensor.

### Pictures, Tiles and Image

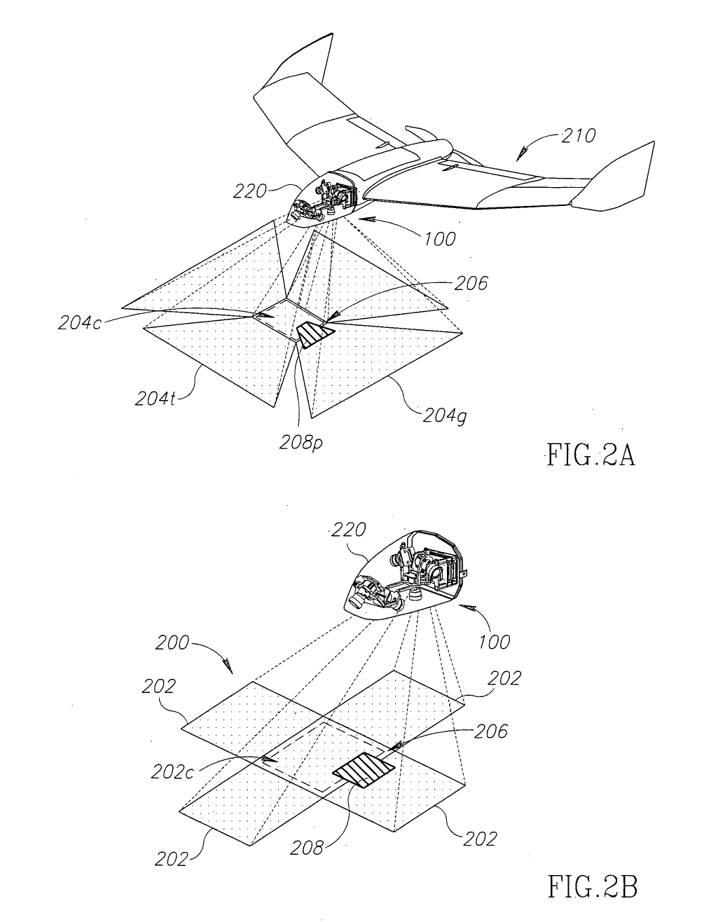

FIG. 2A schematically illustrates rigid imaging system 100 of FIGS. 1A-B installed in the payload compartment 220 of a UAV 210 and the angular distorted zones 204 of pictures captured by cameras 102 of system 100.

In some embodiments, as illustrated for example in FIG. 2A, pictures 204 are acquired along and perpendicular to the direction of the path of flight of UAV 210, possible some overlapping at adjoining margins for continuity, forming a cross-like pattern with wide field-of-view along the latitude and longitude axes with respect to a UAV path of flight.

The pictures footprints (or ‘pictures’) 204 are directed to capture a central zone 204c, two longitudinal zones 204g at the sides of 204c, and two latitudinal zones 204t at the other sides of 204c. Pictures 204 are optionally overlap at the margins 206 thereof due to the inclinations of cameras 102 relative to each other, facilitating combination (‘stitching’) of pictures 204 (or corresponding tiles) into a practically contiguous image.

FIG. 2B schematically illustrates rectangular tiles 202 after correcting (compensating for or rectifying) the distortions of corresponding angularly distorted zones 204 of FIG. 2A, according to exemplary embodiments of the invention.

A region of interest or window of interest is exemplified in FIG. 2A as an angularly distorted region 208p, and in FIG. 2B as a corresponding corrected region 208.

FIG. 2C schematically illustrates a wide field-of-view contiguous image 200 formed by combination (stitching) of rectangular tiles 202 after correcting the distortions of corresponding angularly distorted pictures 204 of zones illustrated in FIG. 2A, according to exemplary embodiments of the invention.

In some embodiments of the invention, the correction formulas are performed on or applied to about a determined region of interest on the sensors of the cameras such as cameras 102 of FIG. 1A-B (distorted pictures 204 held on the sensors). The formulas are applied about the region of interest without accessing, or negligibly accessing, pixels outside the region of interest and the resulting corrected (transformed) region of interest is stored in a memory for further operations (e.g. conversion for transmission). In some embodiments, the correction is performed, at least partially, by mapping locations of pixels in the sensors (in the pictures in the sensors) into different locations in the memory, such as by addressing lookup table. Optionally the mapping to a new location is done by combining (e.g. averaging) two or more pixels into a new location in the memory.

Optionally or alternatively, the pixels of the region of interest (208) are read from the sensors into a memory buffer without accessing the rest of the pixels of the sensors or possibly reading some pixels of adjacent regions for correction operations. The corrections formulas (transformations) are then applied on the memory, possibly with other optional operations such as enhancements or conversion for transmission.

In some preferred embodiments of the invention, stitching and optional alignment are carried out on the sensors of the cameras about the region of interest only, storing the result into a memory for further operations, while accessing only region or region of interest and possibly some neighboring regions required for the operations, while ignoring the rest (typically the majority) of the pixels in the sensors.

In some embodiments, the stitching and/or alignment is performed similarly to the correction formulas, such as by mapping pixels into different location as described above. In some embodiments, the deformations correction is performed before the stitching and/or alignment, whereas in some embodiments the operations order is reversed, yet, in some embodiments of the invention, the distortions correction and the stitching and/or alignment are integrated, at least partially, with the correction formulas.

Consequently to the descriptions above, accessing only (or substantially only) the region of interest on the sensors allows real-time processing, and leaves sufficient time for other operations such as conversion and transmission in real-time without interfering in or delaying the imaging operations (e.g. acquisition, processing, transmission and/or storing) of the current or subsequent view.

Accordingly, in some embodiments, image 200 is in fact partially formed only about the region of interest, where the rest of the image (other pixels of pictures 204 or tiles 202) are ignored; as such, the region of interest is practically moving (‘floating’) on a potential or virtual image 200 in the sensors and the region of interest can be considered as if acquired from a single sensor without (or substantially without) deformations.

In some embodiments, such as for particular purposes, all of pictures 204 on the sensors, or most of the contents of the sensors, are corrected and stitched and aligned (if necessary) as described above, generating rectangular tiles 202 or parts thereof in a memory buffer, forming a rectified wide field-of-view high resolution image 200 or part thereof in the memory buffer.

In some embodiments, only partial correction of angular (perspective) distortions is made, such as to reduce some coarse geometrical distortion. Possible misalignment of pictures 204 are corrected, at least partially, optionally into or as tiles 202. Optionally or additionally, when low-end inexpensive lenses are used in some embodiments, some corrections are carried out for geometric-optical aberrations, mostly around the sensor's image edges, such as barrel, pincushion, etc. In some embodiments the correction of angular deformation, lens aberrations and/or stitching (including possible alignment) are merged in joint formulas as described above, preferably carried out, at least partially, by lookup table or tables, and facilitating real-time operation.

### Sensors Control

With reference to FIGS. 1A-2B, FIG. 3 schematically illustrates a block diagram for forming a contiguous image from a plurality of sensors, according to exemplary embodiments of the invention.

Logic circuitry for sensors control and interface 308 is connected to a plurality of sensors 302 having random access (addressing) to individual pixels or groups of pixels (e.g. row or column or part thereof), such as CMOS sensors. Circuitry 308 controls and interacts with sensors 302 by control lines such as address and read lines represented as dashed line 306, and accesses (reads) pixels off sensors via data line or lines represented as line 304.

In some preferred embodiments of the invention, the plurality of sensors 302 is activated simultaneously (synched) by circuitry 308 and the pictures (pixels) are held in sensors 302 for a certain time (until the next sensor reset command). Pixels in sensors 302 are accessed or read such as row by row or column by column (or as dictated or enabled by the components architecture), optionally addressing the plurality of sensors (or part thereof) simultaneously.

In some embodiments, sensors 302 are addressed similar to memory modules in a computer system; that is, sensors 302 are addressed as parts (or segments) of a common address space, each sensor 302 accessed via a specific address range or by multiplexing the same address range. Optionally or additionally, using address mapping (e.g. lookup table constructed according to overlapping regions and/or distortions corrections) certain pixels in sensors 302 can be ignored (e.g. overlapping margins) and pixels in a perspective or distorted picture can be accesses (e.g. mapped and read) such as if they are in a rectangular window without having to reconstruct the pixels arrangement in a separate memory buffer.

In some embodiments, a window of interest (WOI) 312 that outlines a sub-image, as indicated by dotted bracket, is handled such as by setting and/or maintaining by circuitry 308 a location (address) and size (e.g. width and height) of the window. Window 312 can spread over the pixels of the plurality of sensors 302, as illustrated by window portions 312a and 312b, by altering the address and/or size or shape of the window. In some embodiments, window 312 is handled within one or more sensors 302. For example, panning by modifying the location of window 312 in sensors 302, zooming in or out by changing the size of the window or changing the shape of the window to any form such as rotated rectangle.

In some embodiments, the pixels within and/or about window 312 are read into a memory buffer either as rectified (corrected) window by applying the correction formulas and/or mapping, or, alternatively, reading the pixels within and/or about window 312 directly into a memory buffer and correcting the distortions therein.

In some embodiments, in case window 312 (and possibly close vicinity) is determined to be within a certain sensor 302, the stitching and other operations such as corrections on the remaining sensors are be dispensed of, providing extra execution time for other operations and/or saving power.

Accessing only window 312 (and possibly near vicinity as might be needed for corrections) as a limited portion of the multi-megapixel space of sensors 302 allows handling the WOI pixels in real-time, preferably including formatting and transmission, without disrupting or delaying the on-going operation of the imaging system.

According to the description above, image 200 is virtually or potentially formed on the plurality of sensors 302 via the transformations (‘glasses’) of the corrections formulas. For example, when accessing a particular region on the sensors a rectified (corrected) region is practically accessed by applying the formulas as if taken off a rectified image 200, though in fact not all the pixels of sensors 302 were accessed and corrected.

In some embodiments, the pixels stored in a memory buffer are further handled. For example, zooming by increased resolution, conversion to other formats (e.g. JPEG, VGA) or constructing into a video stream (e.g. MPEG, PAL/NTSC).

In some embodiments of the invention, logic circuitry for sensors control and interface 308 comprises one or more computing units such as FPGA (or other sufficiently fast circuitry such as DSP) and/or one or more processors, providing fast and practically real time operations on the pixels of sensors 302, optionally utilizing parallel operations and/or pipe-line architecture.

In some embodiments, logic circuitry for sensors control and interface 308 is comprised in one or more control boards 106 of imaging system 100 of FIGS. 1-B.

It should be noted that although it is generally illustrated and discussed as if all pictures 204 or tiles 202 are of the same (or of close) size and resolution, yet, without affecting the generality of the descriptions, in some embodiments pictures 204 or tiles 202 are of different size or resolution obtained by using different optics and/or sensors and/or image processing. For example, the center tile 202c is of higher resolution relative to the other tiles 202.

In the following discussions and descriptions, reference is also made to image 200 of FIG. 2C or part thereof, or virtual image 200 or part thereof as a non-limiting illustration. Unless otherwise specified or indicated and without limiting, the reference is made to image 200 as a virtual potential image on sensors 302 where a window (WOI) is moving thereon or read therefrom, optionally and preferably as a rectified (corrected) window or a corresponding sub-image.

### Window-of-Interest (WOI)

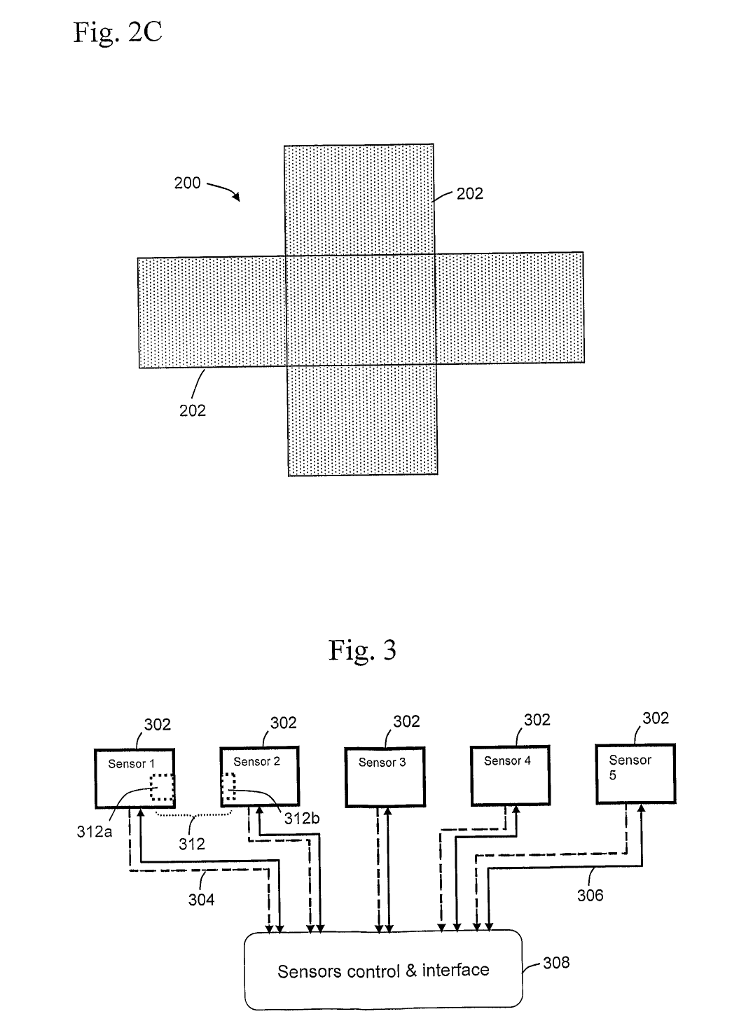

With further reference to FIGS. 2-3, the WOI is defined by a frame having a location and dimensions within the addressing space (pixels) of the sensors (such as sensors 302). The WOI is panned by moving the window's frame coordinates about the image, and the WOI is zoomed in or out by decreasing or enlarging the frame's dimensions, respectively, wherein for tilting the frame is rotated. Similarly and shape or size may be used in the space of the sensors (possibly up to certain margins required for corrections).

It should be emphasized that the WOI setting, panning and zooming or other operations thereon such as tilting are carried out electronically by defining and setting a region in or respective to the potentially contiguous image, as if the WOI was viewed by a single sensor or part thereof, without mechanically moving any part and preferably without accessing pixels that are not relevant to the WOI.

Control boards 106 are linked with the flight control of the UAV and have access to the flight parameters (e.g. GPS coordinates, altitude, attitude, airspeed, etc). As the vehicle maneuvers such as to maintain a flight path, control boards 106 use the flight parameters to pan and/or zoom (and/or tilt) the WOI to maintain a line of sight and/or stable field-of-view of the scene (at least approximately), compensating for the UAV maneuvers and change in location.

As the WOI is selected electronically with no mechanical hindrance the WOI is maintained (‘stabilized’) in real time, keeping a stable view within the field-of-view of image 200.

The image or part thereof, such as the WOI, is stored in memory unit or units on control boards 106, and/or sent to a preset or selected destination, such as ground station, either as still images or as a video stream using equipment and methods of the art.

### Tracking

In some embodiments, using image processing and/or external directives (e.g. via operator link or stored images of possible targets) an object or a collection of objects (‘target’) is identified and kept in the WOI about the center such as by panning or zooming the WOI about the potentially contiguous image 200, thereby tracking the object as long as the target is in the field of view of system 100.

In some embodiments, using image processing and/or external directives a location is marked in the scene and the location is handled similarly to tracking a target as described above, keeping a line-of-sight to the marked location (geographical tracking—Point To Coordinate (PTC) mode of operation).

In some embodiments, when tracking a target or line-of-sight system 100 interacts with the flight control system (Autopilot) of the vehicle by providing the Autopilot with the WOI location relative to the contiguous image 200. Optionally, if required, the Autopilot adjusts the flight parameters and/or sets attitude requirements (e.g. pitch, roll, etc.) such as to keep the target in the field of view, preferably about the center thereof to enable further tracking by the WOI (Camera Guide mode of operation).

### Multiple WOI

In some embodiments, a WOI comprises a plurality of windows-of-interest, defined by respective plurality of frames, providing a plurality of view ports in the image. Without limiting, the descriptions pertaining to one WOI apply, mutatis mutandis, to a plurality of WOI.

### WOI Examples

Some non-limiting examples of using WOI are presented below.

In some embodiments, a window-of-interest frame is formed as one or more contiguously adjoining sub-frames, each in a standard aspect ratio for convenient conversion and/or formatting for transmission and/or for fitting a communication or viewing apparatus. Accordingly, a sub-frame size is a quarter of a tile of image 200 with the same aspect ratio of the tile. Optionally, other factors relative to a tile 202 are used, optionally dependent of the resolution reduction capabilities of the respective sensors.

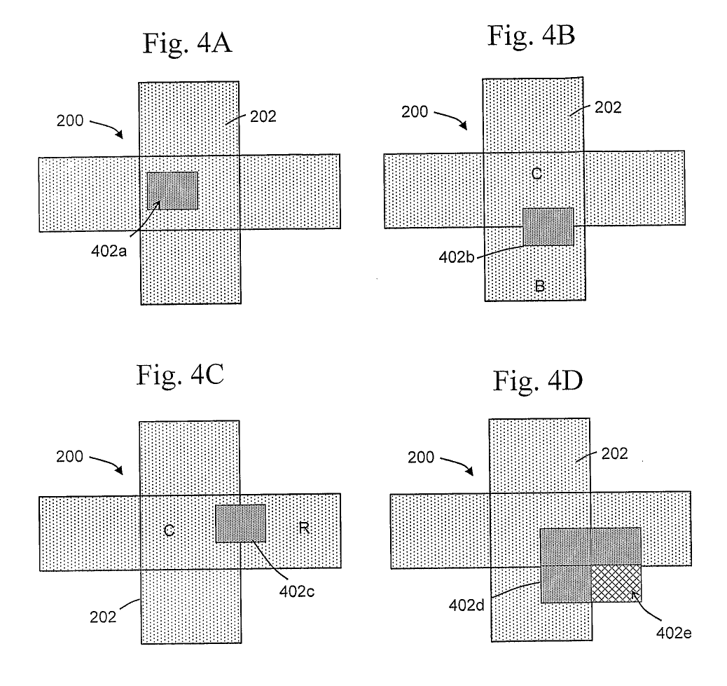

FIG. 4A schematically illustrates a window-of-interest (WOI) 402a in a standard aspect ratio image 200. The WOI can be located anywhere within the limits of image 200.

FIG. 4B-C schematically illustrates a window-of-interest 402b and 402c, respectively, as two sub-frames of standard aspect ratio, and Zoom 2× (relative to the sensor size) on two tiles 202, exemplified by tiles 202 denoted ‘C’ and “B’ and tiles denoted as ‘C’ and ‘R’, respectively. window-of-interest 402b is read by accessing different data lines from sensors ‘C’ and “B’ and window-of-interest 402c is read by accessing the same data lines from both sensors ‘C’ and ‘R’ and connecting the lines together to form a continuous WOI.

FIG. 4D schematically illustrates a window-of-interest 402d as a sub-frame 402d of standard aspect ratio and Zoom 1× (relative to the sensor size). Window-of-interest 402d exemplifies that the frame of WOI may be composed of information for 3 sensors. Missing information 402e will be presented in the picture as ‘black’ pixels.

Using WOI formed as one or more sub-frames of standard aspect ratio is convenient for conversion such as programmatically and/or due to components (e.g. sensors) capabilities and/or for reducing possible loss of visual quality, as well as convenience in transmission and viewing using standard equipment, optionally off-the-shelf components. In some embodiments, the whole WOI is transmitted, or optionally and alternatively, each sub-frame is transmitted separately and optionally arranged back in the viewing equipment (such as in the Wide-Field-of-View viewing mode). In some embodiments, another ratio suitable for transmission and/or viewing, such as 16×9, is used.

### Viewing

In some embodiments of the invention, imaging system such as system 100 of FIGS. 1A-B can operate in several observation or viewing modes, some examples of which are described bellow.

### Window-of-Interest Mode I (Arbitrary)

In a ‘Window-of-Interest mode I’ an unrestricted WOI of a suitable or a determined size (and aspect ratio or shape) is defined and positioned in image 200.

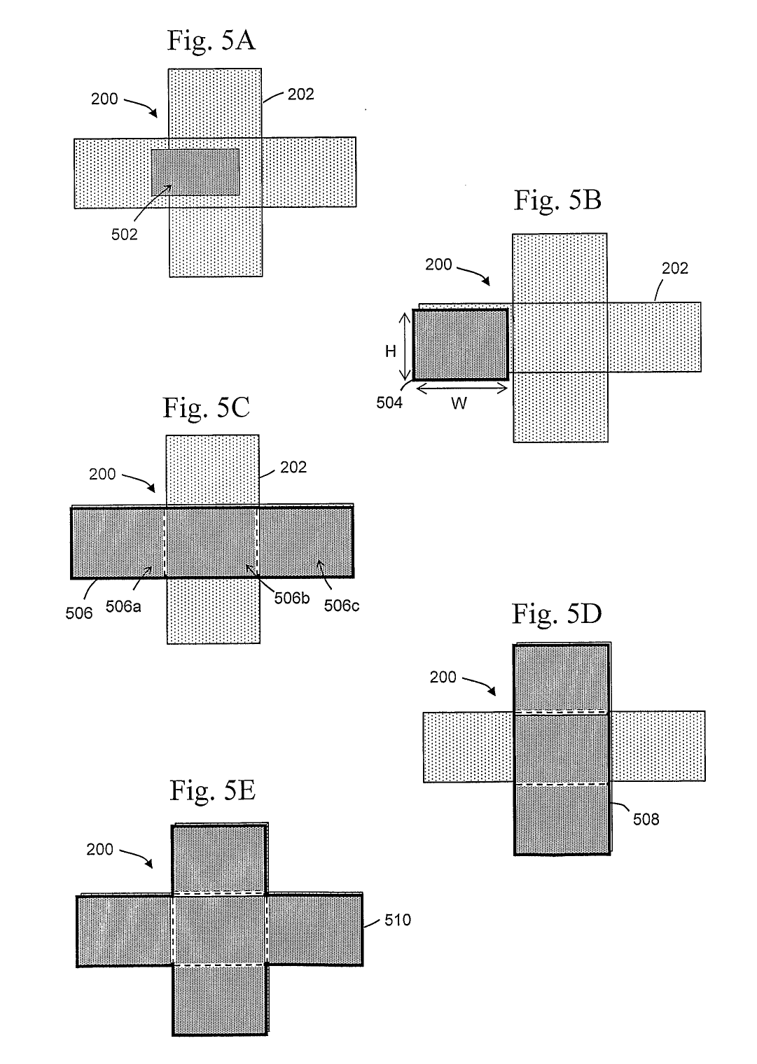

FIG. 5A schematically illustrates an unrestricted or arbitrary window-of-interest 502 as a single partition over image 200 in a Window-of-Interest mode I viewing mode, according to exemplary embodiments of the invention. The qualifier ‘unrestricted’ denote a window that is not restricted to particular location or size or shape or aspect-ratio within in the image.

The contents of window 502 (pixels) can be transferred, such a in a raw format or after conversion to a format of the art such as JPEG, for viewing in a suitable device (e.g. GUI system). Optionally or alternatively, the contents of window 502 is converted, such as to a lower or higher resolution, and encoded in a television standard (e.g. MPEG or PAL or NTSC or HDTV) and transferred for viewing on a television monitor. In some embodiments, the image respective to the WOI is stored or sent as individual snapshots or sequence of snapshots. Optionally or alternatively, the image is encoded for television (including required data such as synch lines) and transmitted as a video broadcast. Preferably the conversion to television standard preserves the aspect ratio of the WOI such as by clipping in case the WOI is not of a standard aspect ratio.

### Window-of-Interest Mode II (Standard)

In a ‘Window-of-Interest mode II’ a WOI in a standard format is defined and positioned to cover a particular tile (respective to a particular sensor 302 of FIG. 3) in image 200.

FIG. 5B schematically illustrates a window-of-interest 504 as a single partition (illustrated with a shift for clarity) matching a tile 202 having width and height (indicated as ‘W’ and ‘H’, respectively) over image 200 in a Window-of-Interest mode II viewing mode, according to exemplary embodiments of the invention. Typically the tile's aspect ratio (W×H) is a standard one, for example 4×3, and the contents the tile is mapped or converted into a standard resolution, such as 640×480, for example, by reducing the high-resolution of the camera sensor to a lower one resolution such as by binning. The tile contents (pixels) is transferred for viewing, optionally after conversion to a television standard such as PAL viewable on a television monitor.

### Window-of-Interest Mode III (Wide)

In a ‘Window-of-Interest mode III’ a WOI of wide aspect ratio encompasses three consecutive tiles (representing generally a plurality of tiles) in image 200, respective to three sensors 302 of FIG. 3.

FIG. 5C schematically illustrates a window-of-interest 506 formed by three corresponding partitions 506a, 506b and 506c matching three consecutive tiles 202 over image 200 in a viewing mode, according to exemplary embodiments of the invention.

Each partition of WOI 506 is of a standard aspect ratio, and typically a tile is of a standard format (such as by resolution reduction) so that an aspect ratio (such as 4×3) is preserved for each partition. According to the description above, each partition is suitably formatted and the image respective to WOI 506 can be sent as a sequence of three snapshot images respective to the partitions. Optionally or alternatively, the image respective to WOI 506 can be encoded in a video stream sent as a sequence of groups of three images respective to the partitions. Optionally, in case the communication bandwidth is not sufficient, the video frame-rate may be reduced.

FIG. 5D schematically illustrates a window-of-interest 508 matching three consecutive tiles in a viewing mode similar and orthogonal to that of FIG. 4C, according to exemplary embodiments of the invention.

### Full Mode

FIG. 5E schematically illustrates a window-of-interest 510 matching the whole image 200 in a viewing mode, similar to a combination of WOI 506 and 508 of FIGS. 5C-D, respectively, according to exemplary embodiments of the invention. The partitions are handled similar to the partitions of WOI 506 and 508.

### Retrieval Mode I (by Time)

In some embodiments, the contents of image 200 or part thereof, according to the viewing mode, is stored in system 100 with indication (tagging) of the time. Upon a directive from a control unit (e.g. by an operator in a control station), the stored contents for requested time or time lapse is retrieved and transmitted for viewing as a high-resolution image. Optionally or additionally, the retrieval and transmission are automatic according to a preset or determined schedule.

### Retrieval Mode II (by Location)

In some embodiments, the contents of image 200 or part thereof, according to the viewing mode is stored in system 100 with indication of the viewed location, such as the location of the center of the WOI or the vehicle's location and other parameters (metadata). Upon a directive from a control unit (e.g. by an operator in a control station), the stored contents for a requested location is retrieved and transmitted for viewing as a high-resolution image. Optionally or additionally, the retrieval and transmission are automatic according to a preset or determined schedule or location.

### Retrieval Mode III (Deferred)

In some embodiments, the contents of image 200 according to the viewing mode is stored in system 100 with indication of the viewed time and/or locations described above and/or other parameters defined in the metadata. Upon landing of the vehicle, or other possible circumstances (e.g. retrieving storage module from a tower, see below) the images are retrieved for viewing and possible analysis.

### Time Considerations

It should be noted that for viewing modes covering a substantial part of image 200 (e.g. ‘Full mode’) the operation of system 100 may be slower relative to viewing modes that cover a smaller part of image 200 (e.g. ‘Window-of-Interest mode II’), possibly reducing the operation to non-real-time or slowing other parallel computations.

### Stabilization

A sequence of images, such as in a video stream, can be visually stabilized such as by cropping the image frame in a way that the center of the image is stable on the account of loosing some contents at the edges. A stabilization program can be integrated into an imaging system such as by integrating with component of control boards 106 of system 100 illustrated in FIG. 1A-B. In some preferred embodiments off-the-shelf stabilization software can be used.

### Visual Quality

It should be noted that using sensor with high pixels count (e.g. 5 MP) allows operations on and manipulations the pixels, such as interpolation or averaging or conversion to lower resolution, without or with insignificant degradation of visual quality or potential quality. For example, when viewing on a monitor after conversion to a format such as PAL or VGA it is expected that the visual quality would be the same or about as if the image was acquired directly in the respective format (not considering effects of lossy compressions).

### Communications

The communications and data transfer between an imaging system, such as system 100 of FIG. 1A-B, and other equipment such as a control station or a relay station uses any technique of the art, typically but no necessarily a radio data link. Typically the system uses communications equipment of the vehicle on which the system is mounted. In some embodiments, the communications and transmission equipment is according to a standard and optionally uses off-the-shelf component. In some embodiments, the viewed image or part thereof is transmitted in analog format such as PAL or NTSC. Optionally or alternatively, the transmission is digital. In some embodiments, the transmission is mixed, such as analog video stream and digital images and control data.

### Night Vision

When operating at night, there is not enough light for a cleared image to be capture in the sensors. In such case, a Star-Light-System (SLS) may be used in conjunction with the sensor's optics (Lens) in order the boost the light generating the image.

### Operation Sequence

According to some embodiments of the invention as described above, exemplary operation method is outlined below with respect to FIG. 6.

The WOI is continuously (smoothly) resized according to command from the Ground Control Station (GCS) or according to the mode of operation of the UAV (602).

The WOI position is defined in one or more of the sensors that are disposed in different orientations (604) and pixels from the WOI are read (606). The position of the WOI is continuously scrolled for compensating, in real time, for changes in a target position relative to the UAV and for the UAV attitude (608).

As one of non-exclusive alternative (622), a continuous video image is provided based on the pixels of the WOI (610), and the continuous video image is transmitted to a GCS, in high frame rate and in multiple resolutions (612) and/or the image is stored, with related metadata (614).

As another non-exclusive alternative (624) a retrievable high resolution still images are provided and retrievably said high resolution still images are stored (616). The high-resolution still images are transmitted to the GCS (618) and/or related metadata is stored along with said images (620).

In some preferred embodiments of the invention, the corrections (or at least a part thereof) are applied only on the viewing window frame and/or contents thereof excluding the rest of the image, yet possibly accessing some pixels outside the window if required or convenient for corrections or alignment (e.g. for interpolation or for substitution), and/or some pixels near the viewing window for convenient manipulation.

### Some Variations

Some non-limiting variations respective to the description above are outlined below,

### Field of View

In some preceding descriptions above the field of view was exemplified by five pictures in a cross-like pattern. Yet, the field of view can be formed by any number of pictures in any preferably continues pattern, provided that processing and accessing a WOI and possible conversion and transmission are sufficiently fast for the requirement of the system operation, typically in real-time. Some patterns are discussed below.

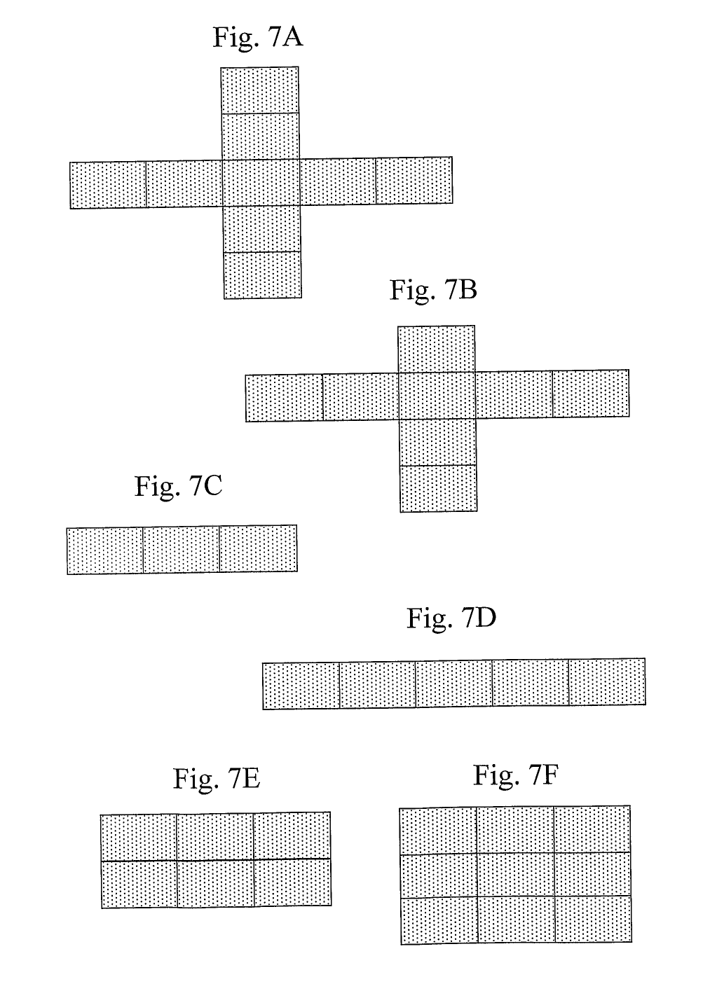

In some embodiments, the cross-like field of view is formed by more than five cameras (or sensors or pictures) such as nine as exemplified and illustrated in FIG. 7A. Optionally, the filed of view is not symmetrical in the sense that the field of view in one direction is different than the other, by the number of cameras (or viewing angles of the lenses), as exemplified and illustrated in FIG. 7B. In some embodiments, the field of view is unidirectional, for example, stretching along the longitudinal or latitudinal axis respective to the line of flight of a UAV as exemplified and illustrated in FIG. 7C (an example for such sensors layout—collecting images during flight for mapping application). Optionally, a unidirectional field of view is formed by more than three cameras as exemplified and illustrated in FIG. 7D, and optionally a rectangular field of view is formed by six or nine cameras as illustrated in FIGS. 7E-F, respectively.

It should be noted that the fields of view illustrated in FIGS. 7A-F (and illustrations such as FIGS. 5A-D as well) are not constrained to any path of flight relative thereto, which may be in any direction including oblique direction relative to a field of view.

### Multi-Spectral

For obtaining further information of a scene or region thereof, viewing in spectrum ranges other than or in addition to visual range can be used. According to some embodiments, in such configuration, a multiplicity of sensors may be used, wherein the sensors may be adapted to look at the same direction (same line-of-site) but each sensor may have different spectrum frequency, for example, Ultra Violet (300-400 nm), Visible/Near Infrared (400-1000 nm), Short Wave Infrared (1-3 μM), Mid Wave Infrared (3-6 μm), or Long Wave Infrared (6-15 μm). Suitable equipment may be used for each range or ranges such as sensors and/or optics. For example, IR-sensitive sensors may optionally be cooled. This configuration, which may also be referred to as spectral imaging combines the strength of conventional imaging with that of spectroscopy to accomplish tasks that separately each can not perform. This configuration allows, according to some embodiments, to perform spectroscopy from a distance using remote sensing techniques. The product of a spectral imaging system may include a “stack” of images of the same object or scene, each at a different spectral narrow band (or “color”). This may allow obtaining frequency related information from the same area of interest, for example, for applications such as: Target and anomaly detection, spectral classification, vegetation analysis for precision farming, chemo-metrics, video based navigation, retrieval of atmospheric parameters or any other area.

The multi-spectral images (and/or any other image(s) obtained according to this disclosure) may be saved in the internal memory during flight (for example, in parallel of transmitting the real-time video) for post processing analysis.

In some embodiments, the cameras or sensors for the other ranges are used instead of the cameras for visual viewing. Optionally or additionally, the sensors for the other ranges are used in conjunction with the visual equipment, such as parallel optics or different sensors sharing the same optics.

It should be noted that referring to a camera implies any sensing device in any radiation wavelength range that can capture a determined field of view. It should be also noted that when physically practical, all or most of the operations and techniques described above for visible radiation apply to non-visible radiations as well.

### Other Platforms

In some embodiments, the UAV may be an aerostat balloon or an airship such as blimp. In some other embodiments of the invention, the imaging system is mounted and operable on a stationary (at least approximately) platform such as a tower or a mountain, wherein the WOI can be manipulated to compensate for wind movements or structural effects. In case the imaging system is mounted on a rotatable platform such as on a tower or mountain, the WOI can optionally interact with the rotation control similarly as described for a flight control of a UAV.

It should be emphasized that referring to UAV does not preclude any other platform and does not limit the scope of the invention.

### Sample Technical Specifications

As non-limiting examples, Table-1 below lists some characteristic of the imaging systems mounted and operable on a UAV according to some embodiments.

TABLE 1

| ITEM | DESCRIPTION |
|---|---|
| Scrolling | Two axis scrolling: Pitch and Roll |
| Rotational speed | 60 deg/sec |
| Camera Motors | none |
| Number of sensors | 5 |
| Pitch angles | +80° (Looking Forward and down 10°) |
| | −80° (Backwards and down) |
| Roll angles | +105° (Looking Right and 15° above the horizon) |
| | −105° (Looking Left and 15° above the horizon) |
| Sensor | Micron MT9P031: |
| | 1/2.5-Inch 5-Mp CMOS Digital Image Sensor |
| Lens | DSL355 miniature multi-megapixel wide-angle |
| | lens |
| Lens field of view | 90° diagonal, 72° × 54° |
| Focus | Manual |
| Night capability | SLS |
| Video Output | Composite PAL |
| Operation Temperature | −10° C. TO 50° C. |
| Power Source | DC 12 V ± 1 V |
| Power consumption | 2 W (Max) |
| Weight of full camera | 180 gr |

### Sensors

As an a non-limiting example, the sensor used in some embodiments is a Micron® MT9P031 CMOS 1/2.5-inch active-pixel digital image sensor with an active imaging pixel array of 2,592H×1,944V, where Table-2 below lists some sample specifications.

TABLE 2

| | |
|---|---|
| Optical format | 1/2.5-inch (4:3) |
| Active imager size | 5.70 mm(H) × 4.28 mm(V), 7.13 mm diagonal |
| Active pixels | 2592 H × 1944 V |
| Pixel size | 2.2 μm × 2.2 μm |
| Color filter array | RGB Bayer pattern |
| Shutter type | Global reset release (GRR), snapshot only; |
| | electronic rolling shutter (ERS) |
| Maximum data rate | 96 Mp/s at 96 MHz (2.8 V I/O) |
| master clock | 48 Mp/s at 48 MHz (1.8 V I/O) |
| Frame Rate | |
| Full resolution | Programmable up to 14 fps |
| VGA (with binning) | Programmable up to 53 fps |
| 720P (1280 × 720) | Programmable up to 60 fps |
| ADC resolution | 12-bit, on-chip |
| Responsivity | 1.4 V/lux-sec (550 nm) |
| Pixel dynamic range | 70.1 dB (full resolution), 76 dB (2 × 2 binning) |
| SNRMA | 38.1 dB (full resolution), 44 dB (2 × 2 binning) |

### Lenses

As a non-limiting example, the lenses used in some embodiments are miniature wide-angle Sunex DSL355, where Table-3 below lists some sample specifications.

TABLE 3

| | |
|---|---|
| Image circle [mm[ | 7.2 |
| Focal length [m] | 4.2 |
| Image resolution | Multi-megapixel |
| F/# | 2.8 |
| Distortion | −4% (full field) |
| Maximum Filed of View | 84° (70° HFOV on 1/2.5 format |
| Relative Illumination | 90% (full HFOV) |
| Chief Ray Angle | <6° (full field) |

### Camera Pointing Accuracy

Each camera is positioned to a specific direction on planes 108 of frame 104 of imaging system 100. Consequently, given the angle of the platform on which system 100 is mounted (e.g. UAV or tower), it is possible to calculate the position of every pixel in the sensor.

In some embodiments, system 100 is intended to be installed and operate on a Micro-UAVs in which the angular accuracy is low relative to a larger and/or a more stable and accurate vehicles, and in some embodiments the cameras are mounted in frame 104 with limited (and inexpensive) mechanical accuracy, rendering the coordinate pointing accuracy to a value about 25 m RMS (given as an exemplary range), Using more accurate frames and/or cameras and/or platforms, a better accuracy can be achieved.

### Benefits

Some of the benefits of the invention, according to some embodiments, are listed below.

Real-time video streaming of views in a wide field-of-view multi-pixels (e.g. 25 MP) contiguous image.

Coverage of a wide field-of-view (e.g. 1920×480) without sacrificing resolution.

Controllable line-of-site and image stabilization in a robust rigid construction with no moving parts.

Small and low-weight (e.g. <200 gr) suitable as micro-UAV payload.

Ability to save in memory/transmit high resolution images in parallel of transmitting real-time video to a Ground Station.

Ability to retrieve High-Resolution Images from memory, base on related metadata, even during flight and in parallel of receiving real-time video in the Ground Station.

### General

All trademarks are the property of their respective owners.

The following non-limiting characterizations of terms are applicable in the specification and claim unless otherwise specified or indicated in or evidently implied by the context, and wherein a term denotes also variations, derivatives, inflections and conjugates thereof.

The terms ‘processor’ or ‘computer’ (or system thereof) is used herein as ordinary context of the art, typically comprising additional elements such memory or communication ports. Optionally or additionally, terms ‘processor’ or ‘computer’ denote any deterministic apparatus capable to carry out a provided or an incorporated program and/or access and/or control data storage apparatus and/or other apparatus such as input and output ports (e.g. general purpose micro-processor, RISC processor, DSP). The terms ‘processor’ or ‘computer’ denote also a plurality of processors or computers connected, and/or linked and/or otherwise communicating, possibly sharing one or more other resources such as memory.

The terms ‘software’, ‘program’, ‘software procedure’ (‘procedure’) or ‘software code’ (‘code’) may be used interchangeably, and denote one or more instructions or directives or circuitry for performing a sequence of operations that generally represent an algorithm and/or other process or method. The program is stored in or on a medium (e.g. RAM, ROM, flash, disk, etc.) accessible and executable by an apparatus such as a processor or other circuitry.

The processor and program may constitute the same apparatus, at least partially, such as an array of electronic gates (e.g. FPGA, ASIC) designed to perform a programmed sequence of operations, optionally comprising or linked with a processor or other circuitry.

In case electrical or electronic equipment is disclosed it is assumed that an appropriate power supply is used for the system operation.

The terms ‘about’, ‘close’, ‘approximate’, ‘practically’ and ‘comparable’ denote a respective relation or measure or amount or quantity or degree yielding an effect that has no adverse consequence or effect relative to the referenced term or embodiment or operation or the scope of the invention.

The terms ‘substantial’, ‘considerable’, ‘significant’, ‘appreciable’ (or synonyms thereof) denote with respect to the context a measure or extent or amount or degree which encompass a large part or most of a referenced entity, or an extent at least moderately or much greater or larger or more effective or more important relative to a referenced entity or with respect the referenced subject matter.

The terms ‘negligible’, ‘slight’ and ‘insignificant’ (or synonyms thereof) denote, a sufficiently small respective relation or measure or amount or quantity or degree to have practical consequences relative to the referenced term and on the scope of the invention.

The terms ‘similar’, ‘resemble’, ‘like’ and the suffix ‘-like’ denote shapes and/or structures and/or operations that look or proceed as, or approximately as the referenced object.

The terms ‘vertical’, ‘perpendicular’, ‘parallel’, ‘opposite’, ‘straight’ and other angular and geometrical relationships denote also approximate yet functional and/or practical, respective relationships.

The terms ‘preferred’, ‘preferably’, ‘typical’ or ‘typically’ do not limit the scope of the invention or embodiments thereof.

The terms ‘exemplary’ or ‘example’ denote a non-limiting illustration and do not limit the scope of the invention or embodiments thereof.

The terms ‘comprises’, ‘comprising’, ‘includes’, ‘including’, ‘having’ and their inflections and conjugates denote ‘including but not limited to’.

The term ‘may’ denotes an option which is either or not included and/or used and/or implemented, yet the option constitutes at least a part of the invention.

Unless the context indicates otherwise, referring to an object in the singular form (e.g. ‘a thing” or “the thing”) does not preclude the plural form (e.g. “the things”).

It is noted that the system and methods described herein, according to some embodiments, may be used in all types of vehicles, such as land vehicles, aerial vehicles (maimed or unmanned aerial vehicles) and under water vehicles.

The present invention has been described using descriptions of embodiments thereof that are provided by way of example and are not intended to limit the scope of the invention or to preclude other embodiments. The described embodiments comprise various features, not all of which are necessarily required in all embodiments of the invention. Some embodiments of the invention utilize only some of the features or possible combinations of the features. Alternatively and additionally, portions of the invention described or depicted as a single unit may reside in two or more separate entities that act in concert or otherwise to perform the described or depicted function. Alternatively and additionally, portions of the invention described or depicted as two or more separate physical entities may be integrated into a single entity to perform the described/depicted function. Variations related to one or more embodiments may be combined in all possible combinations with other embodiments.

In the specifications and claims, unless particularly specified otherwise, when operations or actions or steps are recited in some order, the order may be varied in any practical manner.

Terms in the claims that follow should be interpreted, without limiting, as characterized or described in the specification.

1. A system for providing a continuously scrollable stabilized video image with automatically controllable Line-Of-Site (LOS) and adjustable Field-Of-View (FOV) for use in an Unmanned Aerial Vehicle (UAV), the system comprising:
a plurality of sensors disposed in one or more of orientations;
a computing unit comprising processor adapted to:
define a position and size of a window of interest (WOI) within one or more field-of-views of said plurality of sensors in order to view a Target Of Interest (TOI);
read pixels data from said WOI;
compensate, in real time, for changes in said TOI's position relative to the UAV and for the UAV attitude by, continuously scrolling the position of said WOI; and
provide a continuous high frame rate video image based on the pixels data from said WOI.

2. The system of claim 1, wherein said computing unit further comprises a Field-Programmable Gate (FPGA) and an interface component adapted to manage and control the sensors and wherein said processor is an image processing digital signal processor (DSP).

3. The system of claim 1, further adapted to provide retrievable high-resolution still images, wherein said processor is further adapted to retrievably store high resolution still images with related information in an internal memory device.

4. The system of claim 3, wherein said plurality of sensors further comprise one or more lenses adapted to control the field-of-view and resolution of said video image and/or still images.

5. The system of claim 1, wherein said plurality of sensors are disposed in a plurality of orientations.

6. The system of claim 1, wherein providing said video image is performed after the step of compensating, in real time, for changes in said target position relative to the UAV and for the UAV attitude.

7. The system of claim 1, wherein said position of said window of interest (WOI) is defined based on a command received from a Ground Control Station (GCS).

8. The system of claim 1, wherein said processor is further adapted to continuously (smoothly) resize the WOI upon Ground Control Station (GCS) command or upon automatic selection defined by a mode of operation.

9. The system of claim 1, wherein said continuous video image is a wide field-of-view video image.

10. The system of claim 9, wherein said image comprises of information taken from one sensor or more.

11. The system of claim 1, further comprising a transmitter adapted to transmit said continuous video image to a Ground Control Station (GCS), in high frame rate and in multiple resolutions.

12. The system of claim 11, wherein said transmission comprises PAL 576×720 and HD 1080×1920.

13. The system of claim 1, wherein said processor is further adapted to read pixels data from essentially all sensors and to store said data.

14. The system of claim 1, further comprising a memory adapted to store one or more images along with related metadata.

15. The system of claim 14, wherein said processor is further adapted, upon receiving a command from a user, to pull from storage one or more images and to trigger a transmitter to transmit to a Ground Control Station (GCS) said one or more images.

16. The system of claim 1, wherein said processor is further adapted to stabilize said video image by using one or more image processing algorithms.

17. The system of claim 16, wherein said one or more image processing algorithms comprise maintaining pixels of interest in essentially the same position relative to a screen.

18-24. (canceled)

25. A method for providing a continuously scrollable stabilized video image with automatically controllable Line-Of-Site (LOS) and adjustable Field-Of-View (FOV) for use in an Unmanned Aerial Vehicle (UAV), the method comprising:
defining a position and size of a window of interest (WOI) within one or more of a plurality of sensors disposed in one or more orientations, in order to view a Target Of Interest (TOI);
reading pixels data from said WOI;
compensating, in real time, for changes in said TOI's position relative to the UAV and for the UAV attitude by continuously scrolling the position of said WOI; and
providing a continuous video image based on the pixels data from said WOI.

26. The method of claim 25, further comprising providing retrievable high-resolution still images and retrievably storing said high resolution still images with related information in an internal memory device.

27-46. (canceled)

47. An Unmanned Aerial Vehicle (UAV) comprising a system for providing a continuously scrollable stabilized video image with automatically controllable Line-Of-Site (LOS) and adjustable Field-Of-View (FOV) for use in an, the system comprising:
a plurality of sensors disposed in one or more of orientations;
a computing unit comprising a processor adapted to:
define a position and size of a window of interest (WOI) within one or more field-of-views of said plurality of sensors, in order to view a Target Of Interest (TOI);
read pixels data from said WOI;
compensate, in real time, for changes in said TOI's position relative to the UAV and for the UAV attitude by, continuously scrolling the position of said WOI; and
provide a continuous high frame rate video image based on the pixels data from said WOI.

48. The UAV of claim 47, wherein said system is further adapted to provide retrievable high-resolution still images, wherein said processor is further adapted to retrievabley store high resolution still images with related information in an internal memory device.

49. The UAV of claim 47, wherein said plurality of sensors further comprise one or more lenses adapted to control the resolution of said video image and/or still images.
